(19) United States
(12) Patent Application Publication
(10) Pub. No.: US 2003/0093566 A1
(43) Pub. Date: May 15, 2003

(54) System and method for network and application transparent database acceleration

(76) Inventor: Cary A. Jardin, San Diego, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/039,465

(22) Filed: Nov. 9, 2001

(51) Int. Cl. G06F 15/16

(52) U.S. Cl. 709/246; 709/203

(57) ABSTRACT

A method and system for accomplishing transparent network database acceleration. The architecture determines from the nature of a packet on a network the whether the packet is a database transaction. If the packet is a database transaction, it is suitably intercepted for further analysis. Database acceleration techniques are then suitably implemented based on the type of database transaction. A new packet is then created such that it appears to the devices on the network as though it is an appropriate response to the original packet, even though the original packet was intercepted before arriving at its destination address.

### FIELD OF THE INVENTION

The present invention pertains generally to network-based database acceleration, and more specifically, to network-based acceleration accomplished without modifying existing application infrastructure.

### BACKGROUND OF THE INVENTION

Over the last 40 years, database technologies have become an integral part of corporate Information Technology (IT) infrastructure. More recently, Internet-enabled commerce and real-time information retrieval has more than quadrupled the demand of database infrastructure. Database usage is increasing exponentially, as is the amount of data stored in these databases, and the existing database application and Server platforms are often unable to sustain such growth. One problem facing current databases is that the technology driving these databases is based upon technology created in the 1960's. Also, database applications are often vendor-specific. In other words, applications written to interact with one database platform are incompatible with other database platforms. Consequently, switching from one database platform to another is a costly and time-intensive undertaking.

In addition to lack of compatibility among applications written for different vendor databases, databases are limited by the hardware on which they reside. One method of increasing database performance is to upgrade the database Server hardware. However, upgrading to a new hardware platform is almost as painful as modifying database applications to conform to a new database vendor. One method of upgrading database Servers involves increasing the number of processors in the Server. Unfortunately, increasing the number of processors does not increase performance in a linear manner. It is clear that database performance problems are not solved solely by increasing the number of processors.

There are several common methods of improving database performance aside from upgrading general-purpose hardware. These methods include using specialized database hardware and optimizing database Servers. Databases are generally optimized through the use of caching and transaction routing. However, techniques for boosting database performance generally require modification to the Client or Server applications, or the replacement of hardware. It would be preferable to achieve database acceleration and increased database performance that is transparent to database applications and thus compatible with various database application software as well as existing general-purpose and Server hardware.

### SUMMARY OF THE INVENTION

The present invention disclosed and claimed herein, in one aspect thereof, comprises a method of improving network database performance. The method comprises the steps of determining whether a first network packet involves a database transaction and then intercepting the first network packet upon a positive determination. The packet is then examined to determine the nature of the database transaction. Depending on the nature of the database transaction, a database acceleration technique is selectively implemented. A second network packet is created and at least one of the source and destination addresses of the second network packet are masked based upon the nature of the database transaction of the first packet.

In another aspect thereof, the claimed invention comprises a system for improving network database performance. The system comprises a database server, a client and a database accelerator all communicatively coupled to a network. The database accelerator comprises a packet interrogator for determining whether packets on the network are database transaction packets, determining the source and destination addresses of the packets, and determining the nature of the database transactions. The database accelerator also comprises a packet interceptor for intercepting database transaction packets and a transaction accelerator for accelerating transactions between a database server and a client.

### DESCRIPTION OF THE FIGURES

FIG. 1 illustrates an overall block diagram of the subject system for data packet handling to accomplish database acceleration in connection with the subject invention;

FIG. 2 illustrates an overall system architecture in which the database accelerator is disposed in a network between a database Server and a Client to accomplish the database acceleration;

FIG. 3 illustrates a block diagram of the packet handling for determination of whether a data packet should be intercepted for analysis;

FIG. 4 illustrates a block diagram for a method of accelerating database transactions associated with packets intercepted from a Client machine; and

FIG. 5 illustrates a block diagram for a method of accelerating database transactions associated with packets intercepted from a Server machine.

### DETAILED DESCRIPTION OF THE INVENTION

Transparency to database applications is a very difficult and novel task. It starts by placing the current invention inside the communication channel between a database Client and Server. One method of achieving such transparency is to actively participate in the network infrastructure that connects the Client and Server. One of the most common communication protocols used to transport data from Client to Server is Ethernet. One embodiment of the present invention suitably enables an Ethernet device to sit between the Client and Server to freely route traffic between the Client and Server and siphon off the database traffic that can be accelerated. This is achieved by understanding the electrical impulses, packet structure, protocol, and Client and destination addresses specified in the Ethernet IEEE 802.3 specification. It should be noted that while the presently preferred embodiment is described with reference to Ethernet communication protocols, the present invention is not limited to Ethernet and is suitably applicable to any network protocol, such as token ring. It should also be noted that the Client in the present invention is suitably a database client or an application server.

An Ethernet “packet” can be defined generally as a unit of data at any layer of the Open Systems Interconnect (“OSI”) protocol stack. An OSI protocol stack is a layered set of protocols which work together to provide a set of network functions, wherein each intermediate protocol layer uses the layer below it to provide a service to the layer above. In general, OSI architecture model is a seven layer model having layers, from lowest to highest: 1) physical layer, 2) data link layer, 3) network layer, 4) transport layer, 5) session layer, 6) presentation layer, 7) application layer. The physical layer is the lowest layer and concerns electrical and mechanical connections to the network. The data link layer splits data into frames for sending on the physical layer, receives acknowledgement frames, and performs error checking so that frames not received correctly can be re-transmitted. Thus, it provides an error-free virtual channel to the network layer. The data link layer is split into an upper sublayer, Logical Link Control (“LLC”), and a lower sublayer, Media Access Control (“MAC”). The lower sublayer, the MAC, differs for various physical media and acts as the interface to the physical layer. The MAC layer is responsible for moving data packets to and from one node to another. The LLC, in turn, presents a uniform interface to the network layer controlling frame synchronization, flow control and error checking. The network layer then determines the routing of packets of data from sender to receiver.

Within an Ethernet packet, the preferred embodiment of the present invention statefully understands the flow of traffic from the Client to the Server. Depending on the Ethernet network topology in which the Server exists, the current invention identifies Ethernet packets with a destination Media Access Control (MAC) address, the hardware address of a device, that corresponds to the Server MAC address. In this way, all Ethernet packets bound for the Server (ingress) can be intercepted for further analysis. Likewise the current invention identifies all Ethernet packets with a destination MAC address associated with either the Client or egress IP router. In the case of IP routers, the egress MAC address are suitably identified as configuration parameters. Therefore, all outbound (egress) packets can be inspected for further processing. It is within the embodiment of the current invention to play an active role in the Ethernet communication between the Client and Server. In this way, the current invention suitably modifies the ingress and egress packets to facilitate transparent Ethernet functionality.

The determination to modify ingress or egress packets is made upon the contextual knowledge higher-level communication protocol encapsulated within the data payload of the Ethernet packet. The data and methodology used to modify the ingress and egress Ethernet packets will be specified within subsequent paragraphs.

A communication protocol such as TCP/IP overlays the Ethernet packet and provides a reliable data transportation mechanism between the Client and Server. After the Ethernet traffic is classified as traffic between a Client and database Server, the data contained within the Ethernet packet is framed into TCP/IP (specifically it is IP framed) to determine the nature of the traffic. Within the IP framing of the Ethernet packet exists Client and Server port numbers used to identify the communication channel between the Client and Server. Specifically, the Client opens a connection toward the Server by selecting a connection unique Client port and selecting a service unique Server port. The present embodiment of the current invention utilizes the Server port to determine the intent of the Client connection request.

For example, a Client request with a Server port number of 80 would correspond to an HTTP request. The embodiment of the current invention contains a set of known port numbers for various database services. From the framed IP traffic and a match on the known database Server service port, the current invention determines if the current Server-bound Ethernet packet should be forwarded directly to the Server or locally fulfilled. In the case the packets need to be locally fulfilled, the current invention must assume the IP and MAC address of the database Server ingress packets, as well as assume the IP address of the requesting Client and the MAC address of the Client or egress router (Based on the location of the Client on either a local or remote Ethernet network).

Ethernet and IP transparency has been achieved, and database transactions can be routed in any manner so as to optimize database performance. Generally, 80% of database transactions are read operations and only 20% are write operations. Write operations require only a fraction of the hardware resources that are required to fulfill read operations. Therefore, the current invention can be categorized as a transparent database cache; all read operations are fulfilled by the invention and write operations are handled as an exception, not as a rule, by the database Server. A variety of methods are suitably used to accelerate database read transactions, including but not limited to accelerating read operations, utilizing high-speed memory systems, optimizing sorting hardware and optimizing searching hardware. The present invention makes no claims to any specific means of performing accelerating database read operations. The first generation product embodiment will include a high-speed memory system, optimized sorting hardware and optimized searching hardware. However, in order to utilize these methods of acceleration the data stored in the database Server must be pulled into the embodiment of the current invention. The details pertaining to the cache fetching algorithm, and the cache coherency algorithm used in the embodiment of the current invention are not claimed as novel art. The current invention does stake claim to the novelty of the method used to transparently extract out database content from a Server into the embodiment of the current invention. In this way, the current invention utilizes the Ethernet, IP, and database transparency to load internal storage with database Server content by imitating the appearance and action of the database Client. For example, in the use of a “read-a-head” cache fetch algorithm, the embodiment of the current invention would first recognize an inbound Ethernet packet from the Client to the Server. More so, the framed IP contents of the packet are classified as a database transaction, and scheduled for local fulfillment. Once the IP contents have been processed and the TCP session negotiated, the embodiment of the current invention would decipher the database transaction request to determine an execution strategy.

In the case of a write request, original Client request is sent directly to the database Server for fulfillment and the embodiment of the current invention invalidates the associated local data for future re-loading from the database Server. In the case of a write transaction, the embodiment of the current invention determines if the requested content is locally available. If so, the content is fulfilled through accelerated means as described above.

If the content is not locally stored, or is invalid, the embodiment of the current invention constructs a read request to send to the database Server to load the required data. When the request is ready for submission to the database Server, the embodiment of the current invention utilizes the facilities described as Ethernet and rP transparency to submit the read request to the database Server as the identity of the requesting Client. In this way, the current invention appears to the destination Server as thought it is the Client. Once the read request has been submitted to the database Server, the embodiment of the current invention loads internal storage with the response data from the Server and the fulfills the original Client request by the accelerated means as described above. In this manner, the present invention appears as the Client to the destination Server.

The performance increase provided by the present invention is limited to the data the invention encounters en route between a Client and Server. If database updates occur without network traffic, the current invention will not see that traffic. For write operations, not seeing the transaction equates to no performance increase. For read operations, not seeing the transaction equates to a cache coherence problem; in other words, the data on the current invention does not match the data on the Server. This can be overcome by having the Server update the current invention that such an event has occurred, having the current invention invalidate local data periodically to fetch new data or through any other method that notifies the current invention to the event that was not seen. For example, through the means of standard art database trigger facilities, an event can be internally configured in database Server to update a notification table when changes occur. Through these, and other means the current invention would be able to periodically poll, or get real-time updates of out of bound events

The present invention accomplishes acceleration of database read operations without requiring modification of application logic. Through the use of network and application protocol transparency techniques, the present invention provides the ability to greatly increase the performance of database read operations without modification of existing infrastructure.

Although the preferred embodiment has been described in detail, it should be understood that various changes, substitutions and alterations can be made therein without departing from the spirit and scope of the invention as defined by the appended claims.

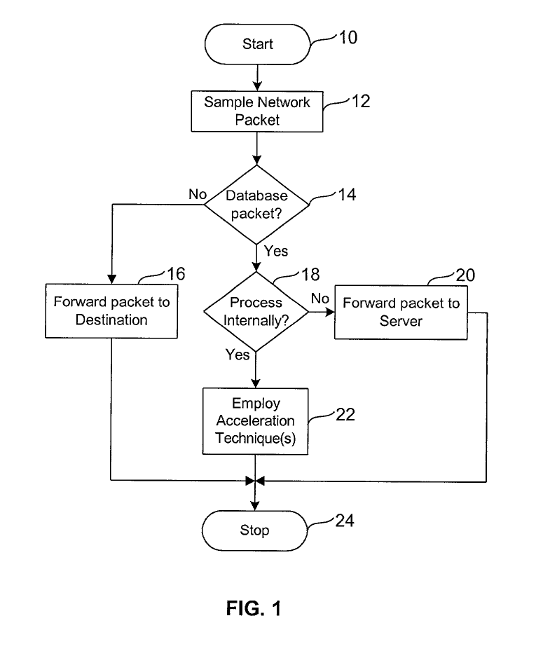

Turning to FIG. 1, an overall block diagram of the subject system for data packet handling to accomplish database acceleration in connection with the present invention is disclosed. The basic flow commences at start block 10, from which progress is made to block 12 at which point a sample packet is taken. The system suitably samples every packet or a subset of data packets. A determination is made at decision block 14 whether the packet at issue includes data representative as to whether the subject packet is a database packet. This determination is suitably accomplished by analysis of a packet header, content of the subject packet, or other suitable criteria as dictated by the particular acceleration application.

A negative determination at decision block 14 causes progress to block 16. At this point, the packet is forwarded along to an appropriate destination as no processing is required. Flow progresses and the system proceeds to stop at termination block 24.

A positive determination at decision block 14 causes progression to decision block 18. At this point, a database packet from an associated Client has been determined to be present. A determination is then made at decision block 18 whether the packet at issue should be processed internally.

A negative determination at decision block 18 causes progression to process 20 wherein the subject packet is forwarded to the database Server for processing. A positive determination at decision block 18 causes progression to process 22 wherein acceleration techniques are employed on the subject packet as will be detailed hereinbelow. Flow then progress from both process blocks 20 and 22 to termination block 24 where the system proceeds to stop.

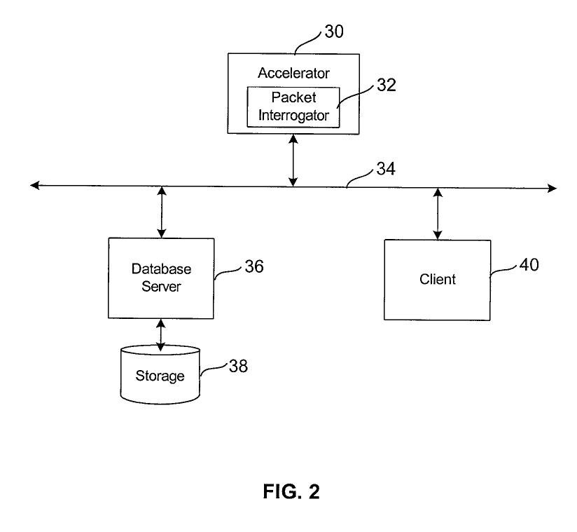

Turning next to FIG. 2, a database network is illustrative of a LAN or WAN environment in which a preferred embodiment database acceleration is provided. An accelerator 30 comprises a packet interrogator 32 that provides a platform to accomplish the functionality noted in connection with FIG. 1, above. The accelerator is in data communication with a data transport system 34, suitably comprised of physical and transport layers such as illustrated by a myriad of conventional data transport mechanisms such Ethernet, Token-Ring™, 802.11 (b), or other wire-based or wireless data communication mechanisms as will be apparent to one of ordinary skill in the art.

The data transport system 34 is also placed in data communication with at least one database Server, a representative one of which is illustrated by database Server 36, which database Server comprises a storage subsystem 38. The database Server 36 is suitably any Server for accommodating selective query support, selective data access, data archiving, and like as will be appreciated to one of ordinary skill in the art. One or more Clients, such as representative Client 40, are also placed, or selectively placed, in data communication with the data transport system 34. It should be noted that a Client 40 is suitably a database client or an application server. Thus, a data path between one or more database Servers, such as that illustrated by database Server 36, is in shared data communication with the accelerator 30 and the one or more Clients, such as Client 40. Thus, the accelerator 30 suitably intercepts data traffic between at least one database Server and at least one Client to allow for acceleration of data therebetween.

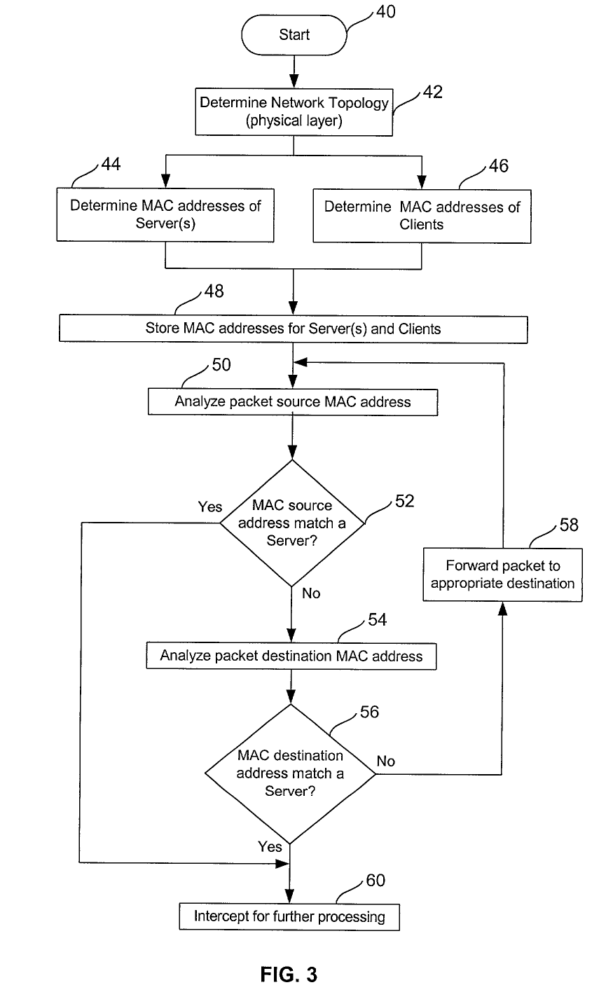

Turning now to FIG. 3, depicted is a block diagram of packet handling for determination of whether a data packet should be intercepted for analysis. The basic flow commences at start block 40, from which progress is made to block 42 at which point the type of network topology is examined. In particular, the physical layer of the network is examined in process 42 so that the packet can be properly analyzed. Flow then progresses and the MAC addresses of the Server(s) and Client(s) are determined at blocks 44 and 46, respectively. Flow progresses to process block 48 where the MAC addresses of the Server(s) and Client(s) are stored. The MAC addresses are suitably stored locally by the accelerator 30 or on any storage device connected to the network transport 34 as shown in FIG. 2 and flow progresses to process block 48.

For each packet sampled in process 12 of FIG. 1, the source MAC address is analyzed in process block 48, after which flow progresses to decision block 52. At decision block 52, a determination is made whether the MAC source address of the sampled packet matches a database Server MAC address determined in process 44 and stored in process 48. A positive determination at decision block 52 means that the packet is a database transaction packet and leads to a progression to process block 60 where the packet is intercepted for further processing.

A negative determination at decision block 52 causes progression to process block 54 wherein the sampled packet destination MAC address is analyzed. Flow progresses to decision block 56 wherein determination is made whether the MAC destination address of the sampled packet matches a database Server MAC address determined in process 44 and stored in process 48. A positive determination at decision block 56 means that the sampled packet is a database transaction packet and flow therefore progresses to process block 60 where the packet is intercepted for further processing.

A negative determination at decision block 56 causes progression to process block 58 wherein the sampled packet is forwarded to its appropriate destination without further processing, as it is not a database transaction packet. Flow then progresses back to process 50 where the next sampled packet's MAC source address is analyzed.

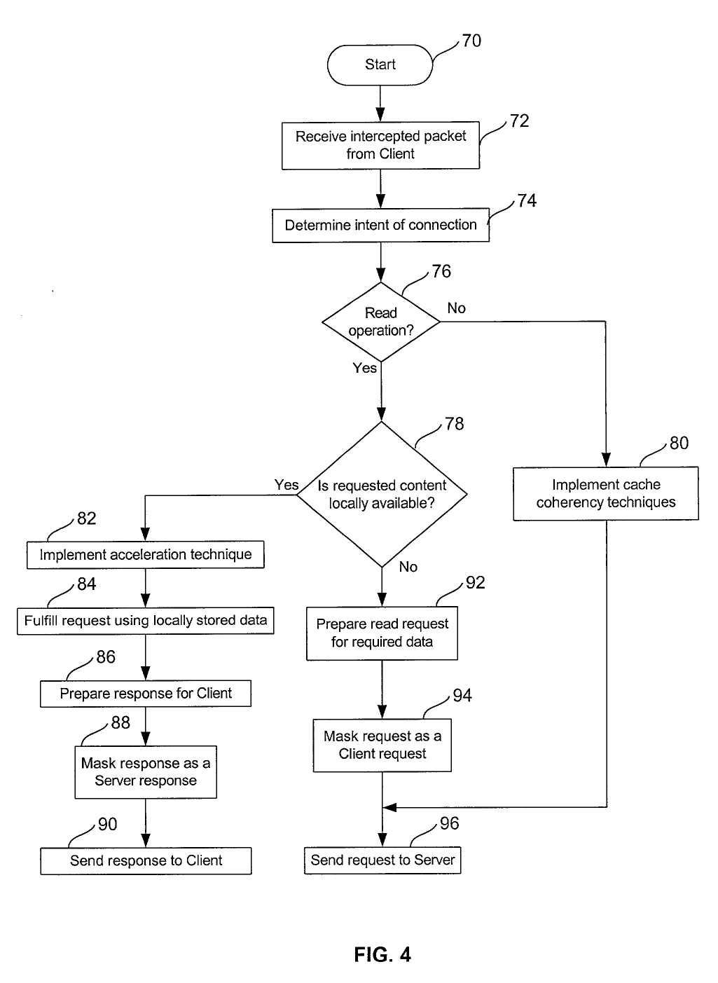

Turning now to FIG. 4, depicted is a block diagram of packet handling after being intercepted between a Client and a database Server upon a positive determination in decision block 56 of FIG. 3. The basic flow commences at start block 70, from which progress is made to block 72 at which point a packet from a Client is intercepted. Progress is made to process block 74 wherein the intent of the connection is determined.

Flow then progresses to decision block 76 wherein a determination is made whether the intercepted packet is a read operation. Upon a negative determination at decision block 76, flow progresses to process block 80 wherein cache coherency techniques are implemented. Flow then progresses to process block 96 where the packet is masked as a Client request.

A positive determination at decision block 76 causes progression to decision block 78 wherein a determination is made whether the content requested is locally available. Upon a positive determination at decision block 78, flow progresses to block 82 where at least one acceleration technique is implemented. Progression continues to process block 84 wherein the request is fulfilled using locally stored data.

After fulfilling the request, progression continues to process block 86 where a response for the Client is prepared. The response is then masked as a Server response at block 88 prior to being sent to the Client at block 90.

A negative determination at decision block 78 causes progression to process block 92 wherein a read request for the required data is prepared. Progression then flows from both process blocks 80 and 92 to process block 94 where the request is masked as a Client request. Following the masking of the request as a Client request, the request is sent to the Server in process block 96.

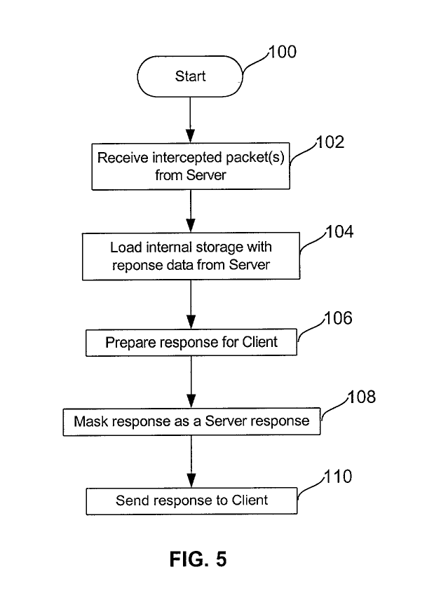

Turning now to FIG. 5, depicted is a block diagram for a method of accelerating database transactions associated with packets intercepted from a Server machine. The basic flow commences at start block 100, from which progress is made to block 102 at which point a packet from a Server is intercepted. Progress is then made to process block 104 wherein internal storage is loaded with data from the Server. Progression then flows to process block 106 where a response based on the packet intercepted from the Server in block 102 is prepared for the Client. Following the preparation of the response, the response is masked as a Server response at process block 108 and progression then flows to process block 110 wherein the masked response is sent to the Client.

Although the preferred and alternate embodiments have been described in detail, it should be understood that various changes, substitutions and alterations can be made therein without departing from the spirit and scope of the invention as defined by the appended claims.

What is claimed is:

1. A method of improving network database performance comprising the steps of:
a) determining whether a first network packet involves a database transaction;
b) intercepting the first network packet upon a positive determination in step a);
c) determining the nature of the database transaction;
d) selectively implementing a database acceleration technique based upon the determination in step c);
e) creating a second network packet; and
f) selectively masking at least one of the source and destination addresses of the second network packet based upon the determination in step c).

2. The method of claim 1 wherein step a) comprises the step of analyzing at least one of the packet's source and destination addresses.

3. The method of claim 2 wherein the source and destination addresses are Media Access Control addresses.

4. The method of claim 1 wherein step c) comprises the step of determining whether the transaction is a read transaction.

5. The method of claim 4 wherein step d) comprises the step of implementing cache coherency techniques upon a negative determination in step c).

6. The method of claim 4 wherein upon a positive determination in step c), step d) comprises the step of determining whether the content requested by the read transaction is locally available.

7. The method of claim 6 wherein upon determination that the content requested by the read transaction is locally available, step d) further comprises the step of fulfilling the read request using locally available data.

8. A system for improving network database performance comprising:
a) a database server communicatively coupled to the network;
b) a client communicatively coupled to the network; and
c) a database accelerator communicatively coupled to the network comprising:
i) a packet interrogator for determining whether packets on the network are database transaction packets, determining the source and destination addresses of the packets, and determining the nature of the database transactions,
ii) a packet interceptor for intercepting database transaction packets, and
iii) a transaction accelerator for accelerating transactions between a database server and a client.

9. The system of claim 8 wherein the network is an Ethernet network.

10. The system of claim 8 further comprising storage communicatively coupled to the network for implementing caching techniques.

11. A system for improving network database performance comprising:
a) a means for determining whether a first network packet involves a database transaction;
b) a means for intercepting the first network packet upon a positive determination in step a);
c) a means for determining the nature of the database transaction;
d) a means for selectively implementing a database acceleration technique based upon the determination in step c);
e) a means for creating a second network packet; and
f) a means for selectively masking at least one of the source and destination addresses of the second network packet based upon the determination in step c).
